(19) United States
(12) Patent Application Publication
(10) Pub. No.: US 2026/0010916 A1
(43) Pub. Date: Jan. 8, 2026

(54) ELECTRONIC DEVICE, SYSTEM, AND METHOD FOR CONSTRUCTING BUILDING-LEVEL GREENHOUSE GAS INDEX INFORMATION

(71) Applicant: MUREPA KOREA LC., Seongnam-si (KR)

(72) Inventors: Ji Young PARK, Seoul (KR); Chang Keun PARK, Busan (KR); Yong Bin LEE, Busan (KR); Hyemin KANG, Busan (KR); Beomsoo JEONG, Chungju-si (KR); Chan KWAK, Chungju-si (KR); Yohan HAN, Cheonan-si (KR); Dongin CHO, Siheung-si (KR); Seunghun LEE, Anyang-si (KR)

(73) Assignee: MUREPA KOREA LC., Seongnam-si (KR)

(21) Appl. No.: 19/333,979

(22) Filed: Sep. 19, 2025

Related U.S. Application Data
(63) Continuation of application No. PCT/KR2025/005596, filed on Apr. 25, 2025.

(30) Foreign Application Priority Data
May 3, 2024 (KR) 10-2024-0059363

(51) Int. Cl. G06Q 30/018

(52) U.S. Cl. CPC G06Q 30/018

(57) ABSTRACT

An electronic device for constructing building-level greenhouse gas index information, is provided. The electronic device can include a processor configured to: match building information including usage type with parcel number-specific energy usage information to generate energy usage information per unit area according to usage type; estimate energy usage information of a non-matched building by using a gross floor area of the non-matched building and the energy usage information per unit area; and construct building-level greenhouse gas index information by using greenhouse gas index information by industry for each city and province and energy usage information according to usage type and parcel number for all buildings.

### TECHNICAL FIELD

The present invention relates to an electronic device, system, and method for constructing building-level greenhouse gas index information.

### BACKGROUND ART

The “National Greenhouse Gas Inventory” published by the Ministry of Environment has provided greenhouse gas emissions data at the national level and the 17 metropolitan and provincial-level local governments. Although, since 2022, greenhouse gas inventories at the basic local government level have been announced, compared to the national level inventory, the information provided is limited, such as the absence of information on detailed sectors. In addition, there is a problem with comparing the total greenhouse gas emissions at the basic local government level with the totals at the city and province level and the national level, where there is a significant difference.

Due to the problems of lack of detailed information and mismatch with totals at the upper-levels (city/province and national levels) in the greenhouse gas inventory at the basic local government unit, there exists a difficulty in establishing interlinkages between the central government and the local governments in formulating the basic plan for carbon neutrality. In addition, the central government and the local governments are also experiencing difficulties in creating a concrete and consistent greenhouse gas reduction roadmap.

As such, in order to develop a concrete and accurate socio-economic scenario, it is necessary to perform a process of estimating greenhouse gas emissions at a detailed spatial level. To this end, public data fully surveyed for energy allocation per building needs to be used, but since population and economic census include personal information, there is a concern about privacy infringement due to excessive disclosure of information when disclosing them 100%. Therefore, in the current state, in case of energy usage information per building, only about 20 to 30% of all buildings are provided, and energy usage information for the remaining 70 to 80% of buildings needs to be estimated.

Currently, only sample data at the 5% level in 5-year intervals are available, but such sample data are not allocated by parcel number, and a building allocation estimation model using secondary data does not exist.

Accordingly, it is necessary to establish a methodology for spatially allocating data at the city and province level on a per-building basis.

### DISCLOSURE

### Technical Problem

The present invention is directed to providing an electronic device, system, and method for constructing building-level greenhouse gas index information.

### Technical Solution

There is provided an electronic device for constructing building-level greenhouse gas index information, according to an embodiment of the present invention. The electronic device may include a processor that is configured to: generate energy usage information per unit area according to usage type by matching building information including usage type with parcel number-specific energy usage information; estimate energy usage of a non-matched building by using a gross floor area of the non-matched building and the energy usage information per unit area; and construct building-level greenhouse gas index information by using greenhouse gas index information by industry for each city and province and energy usage information according to usage type and parcel number for all buildings.

The processor may generate energy usage information according to usage type and parcel number for all the buildings by using the parcel number-specific energy usage information and the energy usage of the non-matched building.

The processor may match energy usage information according to usage type and parcel number for all the buildings with industry classification information, calculate an energy usage ratio of each building within the same industry, and calculate greenhouse gas emissions of each building by using industry-specific greenhouse gas emissions acquired from the greenhouse gas index information by industry for each city and province, and the energy usage ratio of each building.

The industry classification information may include commercial facility information, public facility information, and industrial-use facility information, each including industry classification for each building, and the processor may perform industry classification for all buildings by using the commercial facility information, public facility information, and industrial-use facility information.

The processor may perform industry classification for buildings corresponding to the commercial facility information by using spatial analysis.

The processor may combine the greenhouse gas emissions of each building with map information.

The processor may convert address information included in the parcel number-specific energy usage information into unique number information, and match the unique number information of the building information with the unique number information of the parcel number-specific energy usage information.

There is provided a method of constructing building-level greenhouse gas index information, executed by an electronic device, according to an embodiment of the present disclosure. The method may include: matching building information including usage type with parcel number-specific energy usage information to generate energy usage information per unit area according to usage type; estimating energy usage of a non-matched building by using a gross floor area of the non-matched building and the energy usage information per unit area; and constructing building-level greenhouse gas index information by using greenhouse gas index information by industry for each city and province and energy usage information according to usage type and parcel number for all buildings.

After estimating the energy usage of the non-matched building, the method may include generating energy usage information according to usage type and parcel number for all the buildings by using the parcel number-specific energy usage information and energy usage of the non-matched building.

Constructing of the building-level greenhouse gas index information may include: matching energy usage information according to usage type and parcel number for all the buildings with industry classification information, calculate an energy usage ratio of each building within the same industry; and calculating greenhouse gas emissions of each building by using industry-specific greenhouse gas emissions acquired from the greenhouse gas index information by industry for each city and province, and the energy usage ratio of each building.

The industry classification information may include commercial facility information, public facility information, and industrial-use facility information, each including industry classification for each building, and the matching of the industry classification information may include: performing industry classification for all buildings by using the commercial facility information, public facility information, and industrial-use facility information.

The performance of the industry classification may include: performing industry classification for buildings corresponding to the commercial facility information by using spatial analysis.

After calculating the greenhouse gas emissions of each building, the method may include: combining the greenhouse gas emissions of each building with map information.

The generation of the energy usage information per unit area according to usage type may include: converting address information included in the parcel number-specific energy usage information into unique number information; and matching the unique number information of the building information with the unique number information of the parcel number-specific energy usage information.

There is provided a system for constructing building-level greenhouse gas index information, according to an embodiment of the present disclosure. The system may include at least one management server of a related institution, and an electronic device configured to: match building information including usage type with parcel number-specific energy usage information, received from the management server, to generate energy usage information per unit area according to usage type; estimate energy usage of a non-matched building by using a gross floor area of the non-matched building and the energy usage information per unit area; and construct building-level greenhouse gas index information by using greenhouse gas index information by industry for each city and province and energy usage information according to usage type and parcel number for all buildings.

### Advantageous Effects

According to an embodiment of the present invention, building-level greenhouse gas index information may be acquired and utilized for establishing a national land environmental plan/strategy linked with basic local governments.

According to an embodiment of the present invention, socio-economic data may be constructed at a building level, and the development of a concrete and accurate socio-economic scenario using the same may be enabled.

Further, an environment capable of simulation analysis of urban space using the same may be prepared, and a leading proposal for a model capable of predicting and simulating economic structure may be made possible.

According to an embodiment of the present invention, by estimating the energy usage of all buildings, more accurate building-level greenhouse gas index information may be constructed.

### DESCRIPTION OF DRAWINGS

FIG. 1 is a schematic diagram illustrating a system for constructing building-level greenhouse gas index information according to an embodiment of the present invention.

FIG. 2 is a block diagram illustrating a configuration of an electronic device according to an embodiment of the present invention.

FIG. 3 is a diagram illustrating an operation flow of the electronic device according to an embodiment of the present invention.

FIG. 4 is a diagram illustrating the matching of building information with parcel number-specific energy usage information according to an embodiment of the present invention.

FIG. 5 is a diagram illustrating the estimation of energy usage of a non-matched building according to an embodiment of the present invention.

FIG. 6 is a diagram illustrating a sector and industry linkage model.

FIG. 7 is a diagram illustrating the construction of building information having industry classification attributes according to an embodiment of the present invention.

FIG. 8 is a diagram illustrating the construction of building information having industry classification attributes according to an embodiment of the present invention.

FIG. 9 is a diagram illustrating the calculation of greenhouse gas emissions at a building level according to an embodiment of the present invention.

### MODE FOR DISCLOSURE

Hereinafter, exemplary embodiments according to the present disclosure will be described in detail with reference to the accompanying drawings. The detailed description, which will be disclosed below with reference to the accompanying drawings, is made for the purpose of describing the exemplary embodiments of the present disclosure and is not intended to limit only one exemplary embodiment practiced according to the present disclosure. In the drawings, for clearly describing the present invention, portions not related to the description may be omitted, and the same reference numerals may be used for the same or similar components throughout the entire specification.

In the present invention, a “non-matched building” refers to a building for which the building information, including usage, does not match parcel number-specific energy usage information. Because parcel number-specific energy usage information is not available for all buildings, the energy usage of non-matched buildings may be estimated based on unit-area energy usage information according to usage.

In the present invention, the term “industry classification information” includes industry classification information of each building, public facility information, and industrial facility information as defined by the Korean Standard Industrial Classification (KSIC).

In the present invention, the term “basic local government” refers to an administrative unit among the local governments of the Republic of Korea that is directly related to residents' daily lives, and specifically includes cities (Si), counties (Gun), and districts (Gu).

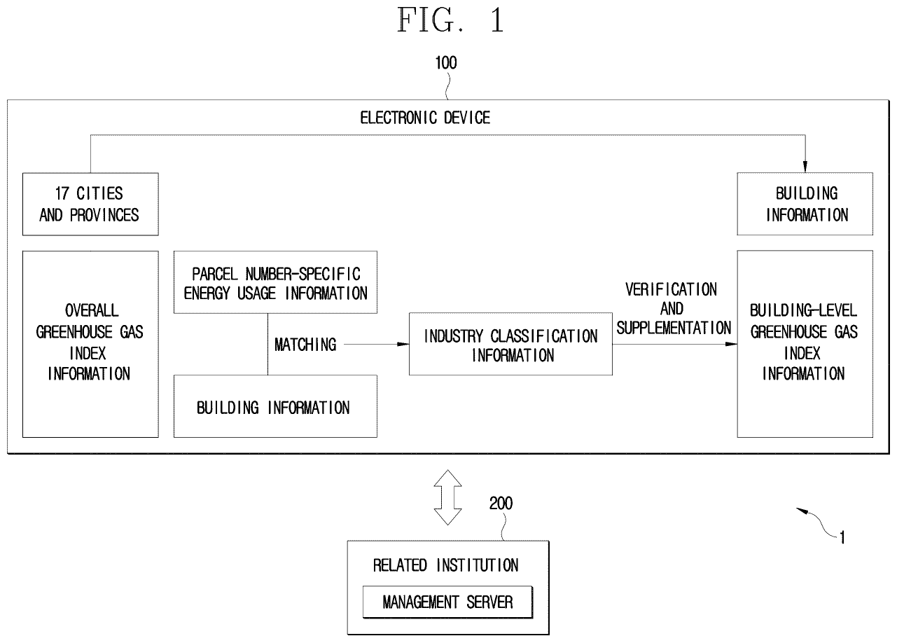

FIG. 1 is a schematic diagram illustrating a system for constructing building-level greenhouse gas index information according to an embodiment of the present invention.

According to an embodiment of the present invention, a system 1 for constructing building-level greenhouse gas index information may include an electronic device 100 and a related institution 200.

The electronic device 100 according to an embodiment of the present invention is a device for constructing building-level greenhouse gas index information, and may be implemented as a computer, a server, a smartphone, a tablet PC, a smart pad, a notebook, and the like.

The related institution 200 is an institution that provides information necessary for constructing building-level greenhouse gas index information, and may be, for example, the Ministry of Land, Infrastructure and Transport, the Ministry of Environment, and the like.

Each related institution 200 may construct a management server and provide information managed by each related institution 200. In this case, the management server may be implemented not only as a server, but also as a computer, a smartphone, a tablet PC, a smart pad, a notebook, and the like.

As described above, according to the national greenhouse gas inventory provided by the Greenhouse Gas Inventory and Research Center of Korea of the Ministry of Environment, greenhouse gas index information for 17 metropolitan and provincial-level local governments is currently being provided. In the present invention, various estimation methods used to allocate the above to building-level greenhouse gas index information are proposed.

First, in view of the fact that parcel number-specific energy usage information is not provided for all buildings, the electronic device 100 matches parcel number-specific energy usage information with building information including usage type. Through this, the electronic device 100 may acquire usage type-specific energy usage information for some buildings to estimate energy usage of a non-matched building.

In addition, based on the fact that greenhouse gas index information is provided by sector (by industry) at the city and province level, the electronic device 100 may match energy usage information of all buildings with industry classification information to estimate greenhouse gas emissions of each building.

According to an embodiment of the present invention, a building-level greenhouse gas inventory may be constructed using greenhouse gas inventory at the national level or basic local government level.

Accordingly, socio-economic data may be constructed at a building level. Further, an environment capable of simulating analysis of urban space using the same may be provided, and a leading proposal of a model capable of predicting and simulating economic structure may be enabled.

Hereinafter, with reference to the drawings, the configuration and operation of the electronic device 100 according to an embodiment of the present invention will be described in detail.

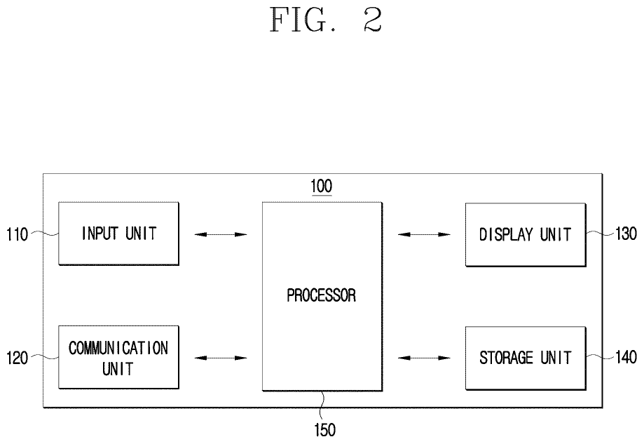

FIG. 2 is a block diagram illustrating a configuration of an electronic device according to an embodiment of the present invention.

The electronic device 100 according to an embodiment of the present invention may include an input unit 110, a communication unit 120, a display unit 130, a storage unit 140, and a processor 150.

The input unit 110 generates input data in response to a user input of the electronic device 100. For example, the user input may be a user input for initiating an operation of the electronic device 100, a user input for setting a key value for matching building information with parcel number-specific energy usage information, a user input for selecting parcel number-specific industry classification information, or the like. In addition to this, a user input necessary for constructing building-level greenhouse gas index information may be applied without limitation.

The input unit 110 includes at least one input means. The input unit 110 may include a keyboard, a keypad, a dome switch, a touch panel, a touch key, a mouse, a menu button, and the like.

The communication unit 120 may perform communication with an external device such as a server to transmit and receive greenhouse gas index information for 17 metropolitan and provincial-level local governments, parcel number-specific energy usage information, building information, industry classification information, building-level greenhouse gas index information, and the like.

To this end, the communication unit 120 may perform wireless communication such as 5th generation communication (5G), Long Term Evolution-Advanced (LTE-A), Long Term Evolution (LTE), Wireless Fidelity (Wi-Fi), Bluetooth, or wired communication such as Local Area Network (LAN), Wide Area Network (WAN), or power line communication.

The display unit 130 displays display data according to an operation of the electronic device 100. The display unit 130 may display a screen for displaying greenhouse gas index information for 17 metropolitan and provincial-level local governments, parcel number-specific energy usage information, building information, industry classification information, building-level greenhouse gas index information, and the like, a screen for receiving a user input, or the like.

The display unit 130 includes a Liquid Crystal Display (LCD), a Light Emitting Diode (LED) display, an Organic Light Emitting Diode (OLED) display, a Micro Electro Mechanical Systems (MEMS) display, and an electronic paper display. The display unit 130 may be implemented as a touch screen coupled with the input unit 110.

The storage unit 140 stores operation programs of the electronic device 100. The storage unit 140 includes storage of a non-volatile nature, which may retain data (information) regardless of power supply, and memory of a volatile nature, into which data is loaded for processing by the processor 150, and which cannot retain data unless power is provided. The storage includes a flash memory, a Hard-Disc Drive (HDD), a Solid-State Drive (SSD), and a Read Only Memory (ROM), and the memory includes a buffer and a Random Access Memory (RAM).

The storage unit 140 may store greenhouse gas index information for 17 metropolitan and provincial-level local governments, parcel number-specific energy usage information, building information, industry classification information, building-level greenhouse gas index information, energy usage information per unit area according to usage type and parcel number, energy usage information according to usage type and parcel number for all buildings, and the like, and may store operation programs or the like necessary in the process of performing operations for generating energy usage information per unit area according to usage type and parcel number, estimating energy usage of non-matched buildings, matching energy usage information according to usage type and parcel number for all buildings with industry classification information, calculating energy usage ratios of each building within the same industry, calculating greenhouse gas emissions of each building, combining greenhouse gas emissions of each building with map information, and the like.

The processor 150 may control at least one other component (e.g., hardware or software component) of the electronic device 100 by executing software such as a program, and may perform various data processing or calculation.

The processor 150 according to an embodiment of the present invention may generate energy usage information per unit area according to usage type by matching building information including usage type with parcel number-specific energy usage information, estimate energy usage of the non-matched building by using the gross floor area of the non-matched building and the energy usage information per unit area, and construct building-level greenhouse gas index information by using greenhouse gas index information by industry for each city and province and energy usage information according to usage type and parcel number for all buildings.

In this case, the processor 150 may construct an analysis model and an analysis model update algorithm, or may receive and store a pre-constructed analysis model and analysis model update algorithm from the outside and use them, but is not limited to either one.

Meanwhile, the processor 150 may perform at least a part of data analysis, processing, or generation of result information for performing the above operations by using at least one of machine learning, neural network, or deep learning algorithm as a rule-based algorithm or an artificial intelligence (AI) algorithm. As examples of neural network, models such as Convolutional Neural Network (CNN), Deep Neural Network (DNN), Recurrent Neural Network (RNN), and transformer may be included.

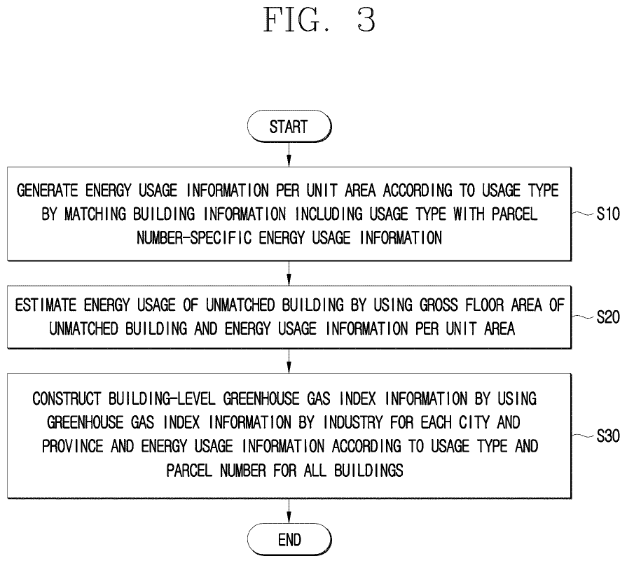

FIG. 3 is a diagram illustrating an operation flow of the electronic device according to an embodiment of the present invention.

According to an embodiment of the present invention, the processor 150 may generate energy usage information per unit area according to usage type by matching building information including usage type with parcel number-specific energy usage information (S10).

The building information includes various information on the corresponding building, and may include, representatively, the usage type of the building (e.g., detached house, multi-unit house, first-type neighborhood living facility, and the like). In addition, the building information may include gross floor area information of the building, and the information included in the building information is not limited to any one.

The parcel number-specific energy usage information may include electricity usage data and gas usage data per parcel number. In this case, as described above, due to reasons such as personal information protection, energy usage information is not disclosed for all buildings, and is disclosed only for some buildings.

The processor 150 may receive the building information and the parcel number-specific energy usage information via an external server, for example, a management server of a related institution that manages each piece of information. For example, the building information may be received from the National Spatial Information Center of the Ministry of Land, Infrastructure and Transport, and the parcel number-specific energy usage information may be received from the Building Administration System of the Green Architecture Division in the Ministry of Land, Infrastructure and Transport. However, the source or receiving path of the corresponding information does not limit the spirit of the present invention.

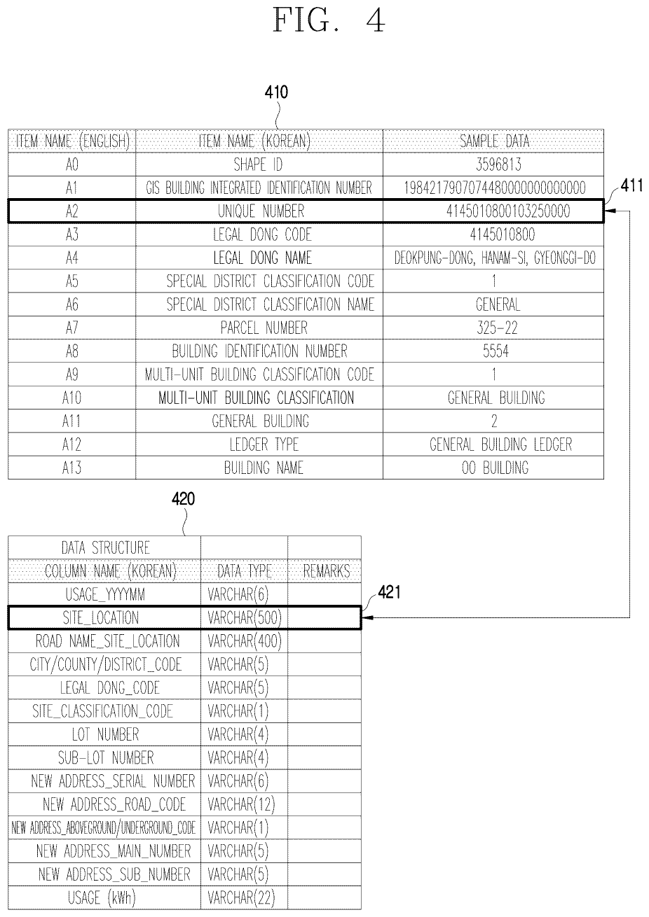

The processor 150 may match the building information with the parcel number-specific energy usage information by using a common key value between the two pieces of information. For example, the two pieces of information commonly include address information, so the processor 150 may match building information with parcel number-specific energy usage information by matching the information with the same address information. An example of the matching method will be described with reference to FIG. 4.

The processor 150 may generate energy usage information per unit area according to usage type by using total energy usage per usage type and the total sum of gross floor areas of buildings having the same usage type.

According to an embodiment of the present invention, the processor 150 may estimate energy usage of the non-matched building by using the gross floor area of the non-matched building and energy usage information per unit area (S20).

Since it is not possible to acquire energy usage information for all buildings, it is necessary to estimate energy usage of buildings for which energy usage information is not provided, so-called non-matched buildings.

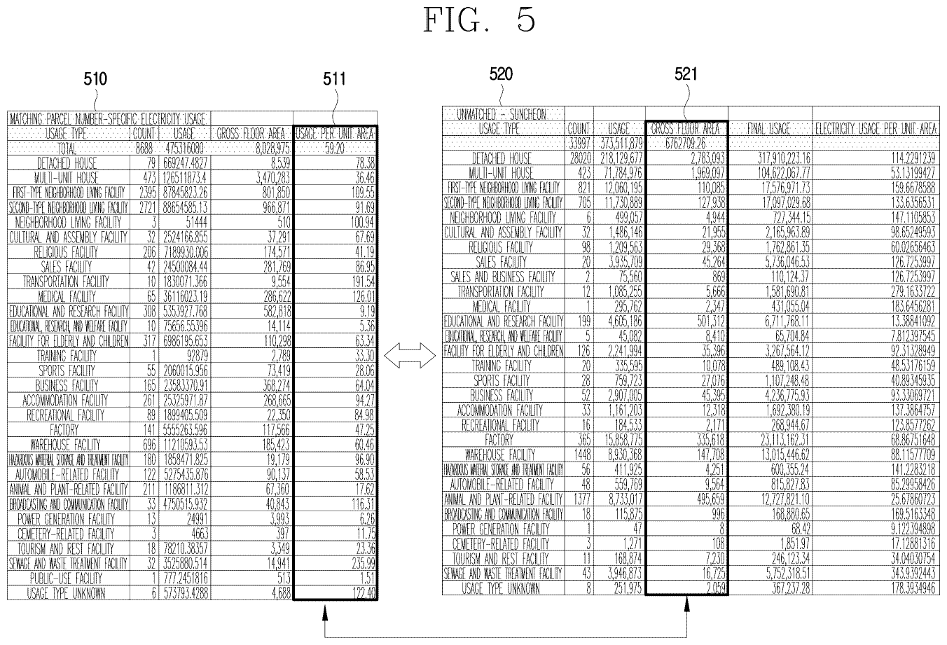

The processor 150 may estimate energy usage of the non-matched building by multiplying energy usage information per unit area according to usage type, acquired in S10, by the gross floor area of each building. In this case, it is natural to identify usage type from building information of each building and to use energy usage information per unit area according to the same usage type. In this regard, description will be made with reference to FIG. 5.

According to an embodiment of the present invention, the processor 150 may construct building-level greenhouse gas index information by using greenhouse gas index information by industry for each city and province and energy usage information according to usage type and parcel number for all buildings (S30).

The processor 150 may generate energy usage information according to usage type and parcel number for all buildings by using parcel number-specific energy usage information and energy usage of a non-matched building.

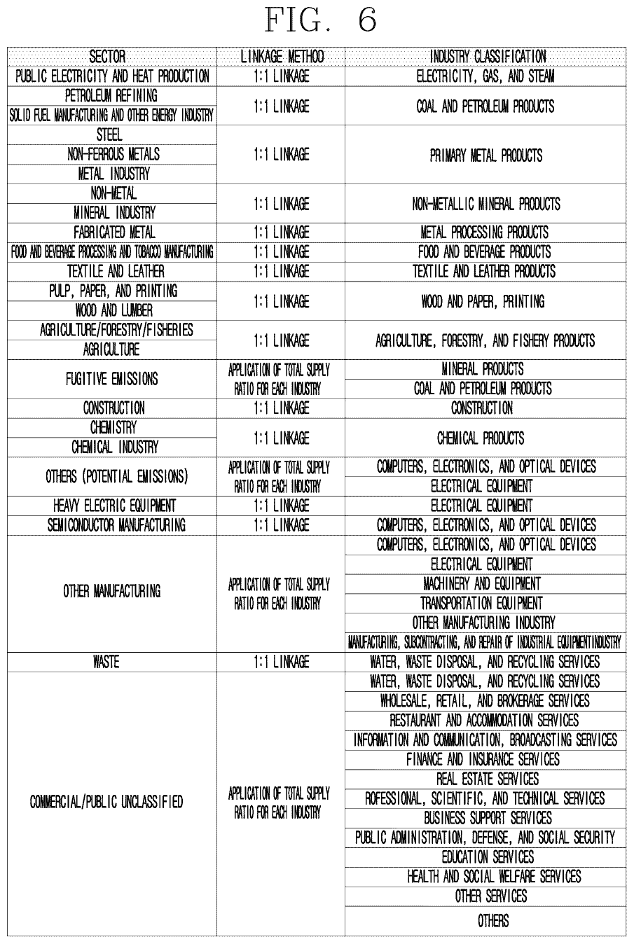

Similarly, the processor 150 may receive greenhouse gas emissions information for 17 metropolitan and provincial-level local governments via an external server, for example, a management server of a related institution that manages each piece of information. For example, greenhouse gas emissions information for 17 metropolitan and provincial-level local governments may be received from the Greenhouse Gas Inventory and Research Center of the Ministry of Environment. However, the source or receiving path of the corresponding information does not limit the spirit of the present invention. In this case, when greenhouse gas emissions information for cities and provinces is collected by sector, a process of converting the collected information by industry will be described with reference to FIG. 6.

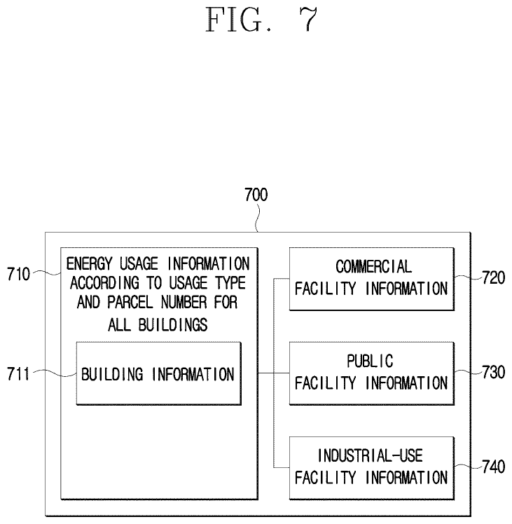

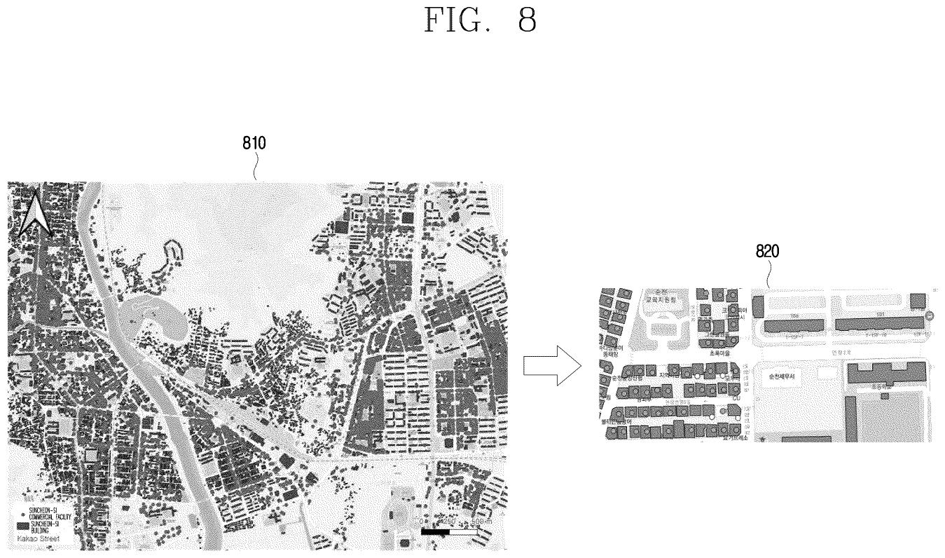

In the present invention, based on the fact that greenhouse gas index information for cities and provinces is made by industry, it is proposed to match energy usage information according to usage type and parcel number for all buildings, acquired through S20, with industry classification information. In this case, the matching method may be various, and in this regard, the description will be made with reference to FIGS. 7 and 8.

That is, by matching energy usage information according to usage type and parcel number for all buildings with industry classification information, the processor 150 may calculate the total energy usage of all buildings existing within the same industry, and an energy usage ratio of each building to the total energy usage.

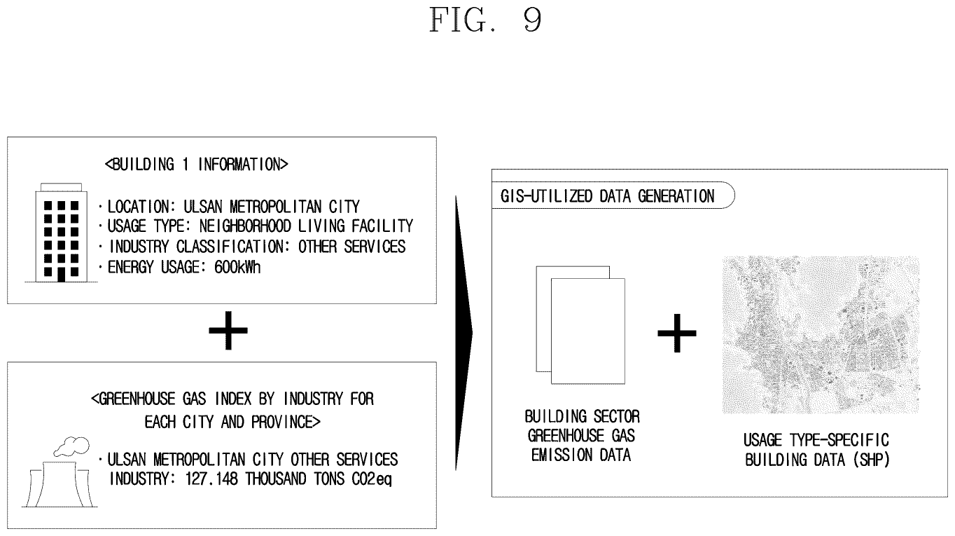

Further, the processor 150 may calculate greenhouse gas emissions of each building by using industry-specific greenhouse gas emissions acquired from greenhouse gas index information by industry for each city and province, and the energy usage ratio of each building. In this regard, a description will be made with reference to FIG. 9.

According to an embodiment of the present invention, building-level greenhouse gas index information may be acquired and utilized for establishing a national land environmental plan/strategy linked with basic local governments.

FIG. 4 is a diagram illustrating the matching of building information and parcel number-specific energy usage information according to an embodiment of the present invention.

As previously described in relation to S10 of FIG. 3, an example of matching building information 410 including usage type with parcel number-specific energy usage information 420 will be described.

The electronic device 100 may use address information, which is a common value, to match the building information 410 with the parcel number-specific energy usage information 420. In this case, as long as the common value is information commonly included in both pieces of information, it is not limited to address information.

Hereinafter, matching the two pieces of information using address information will be described. In this case, address information may be recorded in different formats.

For example, the building information 410 may record an address with a unique number (e.g., PNU code) attached to each parcel to distinguish each parcel from another, and the parcel number-specific energy usage information 420 may record an address with a parcel number.

The electronic device 100 may convert the address information (parcel number) included in the parcel number-specific energy usage information 420 into unique number information, and may match the unique number information of the building information with the unique number information of the parcel number-specific energy usage information. In this case, it is assumed that the method for converting a parcel number into unique number information has already been prepared.

FIG. 5 is a diagram illustrating the estimation of energy usage of a non-matched building according to an embodiment of the present invention.

As previously described in relation to S20 of FIG. 3, a process of estimating energy usage of non-matched buildings will be examined.

The electronic device 100 may acquire energy usage information according to usage type 510 through the matching process according to S10 of FIG. 3.

Specifically, the electronic device 100 may generate energy usage information per unit area according to usage type by using total energy usage per usage type and the total sum of gross floor areas of buildings having the same usage type. That is, the electronic device 100 may obtain usage type-specific energy usage information 511 per unit area by dividing total energy usage per usage type by the total gross floor area of buildings per usage type.

Further, in energy usage information 520 of a non-matched building, the electronic device 100 may estimate energy usage of each building by multiplying the gross floor area of each building and usage type-specific energy usage information 511 per unit area.

According to an embodiment of the present invention, by estimating the energy usage of all buildings, more accurate building-level greenhouse gas index information may be constructed.

FIG. 6 is a diagram illustrating a sector and industry linkage model.

As previously described in relation to S30 of FIG. 3, by utilizing the fact that greenhouse gas emissions information for 17 metropolitan and provincial-level local governments exists by industry, greenhouse gas emissions at a building level may be calculated by matching with the industry classification of the building.

However, when greenhouse gas emissions information for 17 metropolitan and provincial-level local governments acquirable from an external server, or the like, is composed by sector, a task of converting it by industry is required.

The electronic device 100, as illustrated in FIG. 4, may convert sector information of greenhouse gas emissions information for 17 metropolitan and provincial-level local governments into industry information by using a linkage model linking sectors and industries.

FIG. 7 is a diagram illustrating the construction of building information having industry classification attributes according to an embodiment of the present invention.

FIG. 7 describes a process of constructing building information 700 having industry classification attributes.

First, the electronic device 100 may acquire energy usage information 710 according to usage type and parcel number for all buildings through S20 of FIG. 3, and the information 710 may include building information 711 including usage type or parcel number of each building.

The electronic device 100 may match the energy usage information 710 according to usage type and parcel number for all buildings with industry classification information. In this case, the industry classification information may include commercial facility information 720, public facility information 730, and industrial-use facility information 740, including industry classification for each building.

The electronic device 100 may perform industry classification for all buildings by using the commercial facility information 720, the public facility information 730, and the industrial-use facility information 740.

If multiple industries are located within the same building, the electronic device 100 may designate a representative industry of each building as the most frequently aggregated industry in the building. For example, consider a case in which building A has three commercial facilities, and each commercial facility is a supermarket (retail), a restaurant (Korean general restaurant), and a restaurant (Korean general restaurant). In this case, it is considered that the representative industry of building A is Korean general restaurant.

FIG. 8 is a diagram illustrating the construction of building information having industry classification attributes according to an embodiment of the present invention.

The electronic device 100 may use spatial analysis in the process of performing industry classification.

For example, the electronic device 100 may perform industry classification for buildings corresponding to commercial facility information by using spatial analysis.

However, with reference to map information 810 in which commercial facilities and buildings are combined according to spatial analysis in FIG. 8, regions 820 where the buildings and commercial facilities are marginally misaligned may occur in the process of performing the industry classification.

In this case, the electronic device 100 may supplement the map information 810 by combining buildings having the same parcel number with commercial facilities, using the parcel number of the commercial facility.

FIG. 9 is a diagram illustrating the calculation of greenhouse gas emissions at a building level according to an embodiment of the present invention.

As described in relation to S30 of FIG. 3, a process of calculating greenhouse gas emissions per building will be described.

According to the example of FIG. 9, building 1 is located in Ulsan Metropolitan City, its usage type is neighborhood living facility, its industry classification is other services, and its energy usage is 600 kWh.

According to greenhouse gas index information by industry for each city and province, the greenhouse gas emissions from the other services industry located in Ulsan Metropolitan City are 127.148 thousand tons CO₂eq.

First, the electronic device 100 may extract a group of buildings corresponding to the other services industry in Ulsan Metropolitan City, according to the result of matching energy usage information according to usage type and parcel number for all buildings with industry classification information. For example, it is assumed that the result of the extraction is 260 buildings belonging to the other services industry.

The electronic device 100 may calculate an energy usage ratio of each building within the same industry. For example, for the total energy usage of 260 buildings, the energy usage ratio of building 1 is 0.0085. Meanwhile, the electronic device 100 may construct a matrix representing energy usage ratios of each building by industry within the same industry and may identify the energy usage ratio of building 1 by using the same.

The electronic device 100 may calculate greenhouse gas emissions of each building by using industry-specific greenhouse gas emissions acquired from greenhouse gas index information by industry for each city and province, and the energy usage ratio of each building.

For example, it is possible to calculate that the greenhouse gas emissions of building 1 are 1.080758 thousand tons Co2eq, by multiplying the energy usage ratio 0.0085 of building 1 by the greenhouse gas emissions 127.148 thousand tons CO₂eq of the other services industry in Ulsan Metropolitan City.

The electronic device 100, through such a process, may classify 33 industry-specific building groups of cities and provinces, and may construct building-level greenhouse gas index information by multiplying an energy usage ratio matrix for each building group by 33 industry-specific greenhouse gas indices of cities and provinces.

In addition, the electronic device 100 may generate GIS-utilized data by combining greenhouse gas emissions of each building with map information.

1. An electronic device for constructing building-level greenhouse gas index information, comprising:
a memory including at least one instruction; and
a processor configured to execute the instruction,
wherein the processor is configured to:
match building information including usage type with parcel number-specific energy usage information to generate energy usage information per unit area according to usage type;
estimate energy usage information of a non-matched building by using a gross floor area of the non-matched building and the energy usage information per unit area;
match energy usage information according to usage type and parcel number for all buildings with industry classification information of each building;
calculate an energy usage ratio of each building within the same industry;
convert sector information of greenhouse gas emissions information for cities and provinces into industry information by using a linkage model linking sectors and industries;
calculate greenhouse gas emissions of each building by using industry-specific greenhouse gas emissions acquired from the greenhouse gas emissions information for cities and provinces and the energy usage ratio of each building; and
construct building-level greenhouse gas index information by combining the greenhouse gas emissions of each building and map information.

2. The electronic device of claim 1, wherein the processor is configured to generate energy usage information according to usage type and parcel number for all the buildings by using the parcel number-specific energy usage information and energy usage of the non-matched building.

3. The electronic device of claim 1, wherein the processor is configured to perform industry classification for all buildings by using the industry classification information.

4. The electronic device of claim 3, wherein the industry classification information includes commercial facility information, public facility information, and industrial-use facility information, each including industry classification for each building.

5. The electronic device of claim 4, wherein the processor is configured to perform industry classification for buildings corresponding to the commercial facility information by using spatial analysis.

6. The electronic device of claim 5, wherein, when multiple industries are located in the same building, the processor is configured to designate a representative industry of each building as the most frequently aggregated industry in the building and perform industry classification.

7. The electronic device of claim 5, wherein, when regions where buildings and commercial facilities are marginally misaligned occur in the process of performing industry classification by using spatial analysis, the processor is configured to perform industry classification by supplementing map information through combining a building having the same parcel number with the commercial facility, using a parcel number of the commercial facility.

8. The electronic device of claim 1, wherein the processor is configured to:
receive building information and parcel number-specific energy usage information, respectively, through a management server of a related institution managing each piece of information; and
match the building information with the parcel number-specific energy usage information by using a common key value between the two pieces of information.

9. The electronic device of claim 8, wherein the processor is configured to:
convert address information included in the parcel number-specific energy usage information into unique number information; and
match the unique number information of the building information with the unique number information of the parcel number-specific energy usage information.

10. A method of constructing building-level greenhouse gas index information performed by an electronic device, the method comprising:
matching building information including usage type with parcel number-specific energy usage information to generate energy usage information per unit area according to usage type;
estimating the energy usage of a non-matched building by using a gross floor area of the non-matched building and the energy usage information per unit area;
matching energy usage information according to usage type and parcel number for all buildings with industry classification information including industry classification of each building;
calculating an energy usage ratio of each building within the same industry;
converting sector information of greenhouse gas emissions information for cities and provinces into industry information by using a linkage model linking sectors and industries;
calculating greenhouse gas emissions of each building by using industry-specific greenhouse gas emissions acquired from the greenhouse gas emissions information for cities and provinces and the energy usage ratio of each building; and
constructing building-level greenhouse gas index information by combining the greenhouse gas emissions of each building and the map information.

11. The method of claim 10, further comprising:
generating energy usage information according to usage type and parcel number for all the buildings by using the parcel number-specific energy usage information and the energy usage of the non-matched building.

12. The method of claim 10, wherein the matching of the industry classification information comprises:
performing industry classification for all buildings by using the industry classification information.

13. The method of claim 12, wherein the industry classification information includes commercial facility information, public facility information, and industrial-use facility information, each including industry classification for each building.

14. The method of claim 13, wherein the performing of the industry classification comprises:
performing industry classification for buildings corresponding to the commercial facility information by using spatial analysis.

15. The method of claim 14, wherein the performing of the industry classification comprises:
when multiple industries are located in the same building,
designating a representative industry of each building as the most frequently aggregated industry in the building and performing industry classification.

16. The method of claim 14, wherein the performing of the industry classification comprises:
when regions where buildings and commercial facilities are marginally misaligned occur in the process of performing industry classification by using spatial analysis,
performing industry classification by supplementing map information through combining a building having the same parcel number with the commercial facility, using the parcel number of the commercial facility.

17. The method of claim 10, wherein the generating of the energy usage information per unit area according to usage type comprises:
receiving building information and parcel number-specific energy usage information, respectively, through a management server of a related institution managing each piece of information; and
matching the building information with the parcel number-specific energy usage information by using a common key value between the two pieces of information.

18. The method of claim 17, wherein the generating of the energy usage information per unit area according to usage type comprises:
converting address information included in the parcel number-specific energy usage information into unique number information; and
matching the unique number information of the building information with the unique number information of the parcel number-specific energy usage information.

19. A system for constructing building-level greenhouse gas index information, the system comprising:
at least one management server of a related institution; and
an electronic device configured to:
match building information including usage type with parcel number-specific energy usage information, received from the management server, to generate energy usage information per unit area according to usage type;
estimate energy usage of a non-matched building by using a gross floor area of the non-matched building and the energy usage information per unit area;
match energy usage information according to usage type and parcel number for all buildings with industry classification information including industry classification of each building;
calculate an energy usage ratio of each building within the same industry;
convert sector information of greenhouse gas emissions information for cities and provinces into industry information by using a linkage model linking sectors and industries;
calculate greenhouse gas emissions of each building by using industry-specific greenhouse gas emissions acquired from the greenhouse gas emissions information for cities and provinces and the energy usage ratio of each building; and
construct building-level greenhouse gas index information by combining the greenhouse gas emissions of each building and map information.

20. The system of claim 19, wherein the electronic device comprises:
an input unit configured to generate input data in response to a user input;
a communication unit configured to perform communication with an external device to transmit and receive information necessary for constructing greenhouse gas index information;
a display unit configured to display data according to an operation of the electronic device;
a storage unit configured to store operation programs of the electronic device; and
a processor configured to control at least one other component of the electronic device and perform data processing and calculation.
